(19) United States
(12) Patent Application Publication
(10) Pub. No.: US 2025/0123158 A1
(43) Pub. Date: Apr. 17, 2025

(54) TEMPERATURE INDICATION LABELS

(71) Applicant: MICROTEK LABORATORIES, INC., Dayton, OH (US)

(72) Inventors: Steve Yeager, Miami Township, OH (US); Leslie Teague, Hollansburg, OH (US); Olivia Davis, Dayton, OH (US)

(73) Assignee: MICROTEK LABORATORIES, INC., Dayton, OH (US)

(21) Appl. No.: 18/912,884

(22) Filed: Oct. 11, 2024

Related U.S. Application Data
(60) Provisional application No. 63/590,115, filed on Oct. 13, 2023.

(51) Int. Cl. G01K 11/16; G01K 3/00; G01K 13/00; G09F 3/00; G09F 3/02; G09F 3/10

(52) U.S. Cl. CPC G01K 11/16; G01K 3/005; G01K 13/00; G09F 3/0291; G09F 3/10; G09F 2003/028

(57) ABSTRACT

Temperature indication labels, including low temperature ascending indication labels, that provide a visible color change when a temperature rises above a target temperature, in some applications a target temperature below room temperature. For low temperature ascending indication labels, the indicator needs activated by cooling or freezing. A transparent polymer layer is present over a deposition of a temperature indication composition in a suitable thickness to protect (insulate) the same from environmental interference, such that the temperature indication composition better reflects the temperature of the thermal mass to which it is adhered and intended to monitor. One example application a low temperature ascending indication label is a blood bag filled with blood, which is stored at 6° C. and transported at 10° C. Another is refrigerated storage of medical items and food to be stored in a range of 2° C. to 8° C.

### TECHNICAL FIELD

The present application relates to temperature indication labels, more particularly, to temperature indication labels having a pressure sensitive adhesive backed substrate having a deposit of a temperature indication composition thereon protected from environmental interference by a transparent polymeric layer (dome layer) of suitable thickness.

### BACKGROUND

Commercial products that require temperature control post-manufacturing, i.e., during the supply chain—shipping, storage, and distribution prior to use or consumption, sometimes utilize a temperature indictor label on the product or on a box or other shipping container. Examples include frozen foods and/or refrigerated foods, including seafood, vegetables, etc., pharmaceuticals, including medicines and blood bags. Taking bags of whole blood as an example, after being collected from a donor, the blood bags are processed at a blood center that separates the whole blood into four main components: red blood cells, platelets, plasma, and cryoprecipitate. Red blood cells are stored in cold storage between 1° C. and 6° C. Once the red blood cells are requisitioned from the hospital, they enter the supply chain for blood wherein the red blood cell bag is required to be maintained at a temperature between 1° C. and 10° C.

There are several low temperature ascending temperature indicators on the market, the most important of which are the blood bag temperature indicators. These products have one or more of the following problems:
Large size: the available space for application of an indicator label to the blood bag as a primary label (not as a secondary label on top of the main identification label) is limited, so a small label is beneficial.
Difficult to interpret: The color change that indicates a temperature excursion above the target temperature can be difficult to see, for example a color change from blue to blue gray. Also, the window for viewing the color change may be small.
Bulky/Rigid: A rigid indicator construction can result in difficulty adhering to a flexible blood bag and difficulty maintaining adhesion. A thick, raised indicator can become caught on edges during movement and potentially be dislodged.
Must be applied to the blood bag 24 hours prior to use, which requires preplanning and can limit quick response for blood request.
A time delay: if the indicator approaches the trigger temperature but never indicates and the bag is returned to the refrigerator, it could show an indication as migration of indication solution continues. Another scenario—it could have reached trigger temperature but did not indicate while handling.
Activation Equipment is required: an activation unit may be required to be kept near the application area. For example, a UV light exposure box or a warming bath.
Susceptible to UV light degradation.

Temperature ascending and descending indicators have been developed utilizing thermochromic inks as indicators. Traditional thermochromic inks have no hysteresis and are considered reversible. Those with a hysteresis, meaning a difference between their color change temperature upon warming versus that upon cooling, can be used to record a temperature excursion. An example of an indicator using this technology would be an 8° C. ascending indicator that develops color when chilled below −5° C. (activation), applied at refrigeration temperatures, and then changes from colored to colorless when it exceeds 8° C. It will not revert to its colored state unless chilled back to −5° C., so the indication is considered permanently recorded.

There are two main problems with thermochromic inks related to their composition. There are three major components in thermochromic inks-leuco dye, developer, and a solvent with a melting point (or freeze point if used as a freeze indictor) in the indication range. The temperature and accuracy of the color change are dictated by the melt and freeze point of the solvent. Some solvents are prone to supercooling, especially when microencapsulated, so the melt and freeze points can be quite different as shown in the patents. This is referred to as hysteresis. The first problem is that the leuco dye and developer act as contaminants in the solvent resulting in broad melt and freeze points. So, the color change occurs over a wide temperature range, of which 5° C. is typical. Second, these inks have a residual color. They are never perfectly clear but will appear to have a slight color when above the target temperature.

The Single Color Reversible Temperature Indicator of U.S. Pat. No. 9,902,861, which behaves like a thermochromic ink with hysteresis but is more accurate and has a distinct and complete color change. This indicator uses the change in opacity of an organic compound when changing phases from liquid to solid for temperature indication. Because the organic compounds are very pure, the melting points (and freeze points) are precise, providing a change in opacity can occur over less than 1° C. Because no dye is required, there is no residual color, so the color change is complete and easily interpreted.

Temperature indicator labels attached to a thermal mass, such those listed above, will detect the temperature of the thermal mass. One drawback to such labels is that the temperature indicator labels can also detect the temperature of the surrounding environment. For instance, should a gloved-hand touch the temperature-sensitive ink, the coating over the ink will begin to detect the gloved-hand's thermal energy and effectively switch its detection from the thermal mass, for example a blood bag full of blood, to the gloved hand. Detection of the environment can result in a false reading of exposure to a temperature at or above a threshold temperature.

Also, activated indicators that must be stored in refrigeration, must be removed from refrigeration, and applied to the thermal mass at room temperature. There is a need to extend the time over which the indicator may be applied to a thermal mass without triggering a temperature change in the temperature-sensitive ink.

There is a need for improved temperature indicator labels that have sufficient thermal mass in its construction so that it will remain temperature stable for a reasonable amount of time and be effective to detect the temperature and/or temperature exposure of a product without being sensitive to environmental temperatures acting directly on the temperature indication composition.

### SUMMARY

In all aspects, temperature indication labels are disclosed that have a substrate with an adhesive layer applied to a bottom surface thereof and a graphic layer or background color layer applied to the opposing top surface thereof. The substrate has a thickness in a range of 2 mil to 15 mils. A deposit of a temperature indication composition is present on at least a portion of the graphic layer or background color layer, and a transparent polymeric layer has been applied over the deposit, thereby sealing the deposited temperature indication composition to the substrate. The transparent polymeric layer has a thickness in a range of 10 mils to 90 mils. The temperature indication composition comprises a binder and an organic compound. The organic compound is one having hysteresis at a pre-selected temperature for an irreversible color change from colored to transparent within an operable range for a thermal mass to which the temperature indication label is intended for adhesion and is one having a refractive index the same as or closely matching the refractive index of the binder. The deposit of temperature indication composition has a dried thickness in a range of 3 mils to 8 mils, and typically the organic compound has a purity of at least 92% and includes at least one carbon ring. In one embodiment, the binder is polyvinyl alcohol.

In one embodiment, the organic compound is encapsulated in a microcapsule having a mean particle size in a range of 1 μm to 50 μm. The organic compound can be encapsulated in a microcapsule having a mean particle size in a range of 10 μm to 40 μm.

In another embodiment, the temperature indication composition was deposited as an aqueous dispersion of the organic compound in polyvinyl alcohol. Optionally, the organic compound had a mean particle size less than 12 μm. In one embodiment, the organic compound includes benzyl laurate, the binder includes polyvinyl alcohol, the thermal mass is a blood bag of blood, and the operable range for a color change indication of the temperature indication label is 3° C. to 10° C.

In all embodiments, the substrate can be one or more of biaxially oriented polypropylene (BOPP), polypropylene, polyethylene, polyvinyl chloride, cellulose acetate, polyester, polyester-G, or cyclic olefin copolymer films, paper laminations, foil laminations and combinations thereof. In all embodiments, the transparent polymeric coating can be one or more of polyurethanes, silicones, acrylics, epoxies, and combinations thereof. In all embodiments, the organic compound can be one or more of benzyl laurate, benzyl myristate, benzyl stearate, dimethyl 1,4-cyclohexanedicarboxylate, butyrophenone, dodecanophenone, p-xylene, benzhydryl laurate, and 2-naphthyl laurate and/or one or more of ethyl myristate, pentacosane, isopropyl palmitate, 2-undecanone, nonanoic acid, 1,8-dibromooctane, and cetyl stearate.

Optionally, temperature indication labels can also include a liquid crystal ink real-time temperature measuring scale.

In another aspect, low temperature ascending indication labels are disclosed that have a substrate with an adhesive layer applied to a bottom surface thereof and a graphic layer or background color layer applied to the opposing top surface thereof. The substrate has a thickness in a range of 2 mil to 15 mils. A deposit of a temperature indication composition is present on at least a portion of the graphic layer or background color layer, and a transparent polymeric layer has been applied over the deposit, thereby sealing the deposited temperature indication composition to the substrate. The transparent polymeric layer has a thickness in a range of 10 mils to 90 mils. The temperature indication composition includes polyvinyl alcohol and an organic compound. The organic compound has a hysteresis at a pre-selected temperature for an irreversible color change from colored to transparent within an operable range for a thermal mass to which the temperature indication label is intended for adhesion, and is selected from the group consisting of benzyl laurate, benzyl myristate, benzyl stearate, dimethyl 1,4-cyclohexanedicarboxylate, butyrophenone, p-xylene, ethyl myristate, pentacosane, isopropyl palmitate, 2-undecanone, nonanoic acid, 1,8-dibromooctane, and combinations thereof. In most embodiments, the deposit of temperature indication composition has a dried thickness in a range of 3 mils to 8 mils. In most embodiments, the organic compound has a purity of at least 92%.

In at least one embodiment, the temperature indication composition was deposited as an aqueous dispersion of the organic compound in the polyvinyl alcohol. Optionally, the organic compound has a mean particle size less than 12 μm.

### BRIEF DESCRIPTION OF THE DRAWINGS

FIG. 1 is a longitudinal cross-sectional representation through an embodiment of a temperature indication label showing the stack-up of layers.

FIG. 2 is a first embodiment of a temperature indication label.

FIG. 3 is a second embodiment of a temperature indication label.

FIG. 4 is a representation of a triggered indicator label with respect to either of the embodiments of FIG. 2 or 3.

FIG. 5A is a table of data for hysteresis of 12 organic compounds.

FIG. 5B is a table of data for hysteresis of 4 additional organic compounds.

FIG. 6 presents chemical structures for example organic compounds tested for use in the temperature indication composition.

FIG. 7 is table of data of “resistance to color change when touched” for various temperature indication labels.

FIG. 8 is a third embodiment of a temperature indication label in its manufactured un-activated state transitioned to an activated state.

### DETAILED DESCRIPTION

The following detailed description will illustrate the general principles of the temperature indicator labels and the temperature indication composition contained therein, examples of which are additionally illustrated in the working and comparative examples. The temperature indicator labels are designed for attachment to a thermal mass, like those discussed in the Background above, such as a blood bag, and will detect the temperature of that thermal mass. The temperature indicator labels disclosed herein overcome the problems discussed above. In doing so, the labels will have the following attributes:
(1) Small size: size can be vary based on customer's application and desired graphics, but it can be as small as 0.25″×0.25.″
(2) Thin: Maximum thickness will be ⅛″.
(3) Flexible: deforms with the substrate.
(4) Easy to interpret: the color change is clear and visible.
(5) Accurate: to ±0.5° C. at the trigger temperature of the product core (also called a “thermal mass” herein).
(6) Activation: Activate by freezing, then storing in refrigeration on a product. Either apply when ready to ship or pre-apply on product. Can also be shipped to customer pre-activated. When received, they can then be immediately placed in the refrigerator by the customer and are ready for use.
(7) Unaffected by UV light.

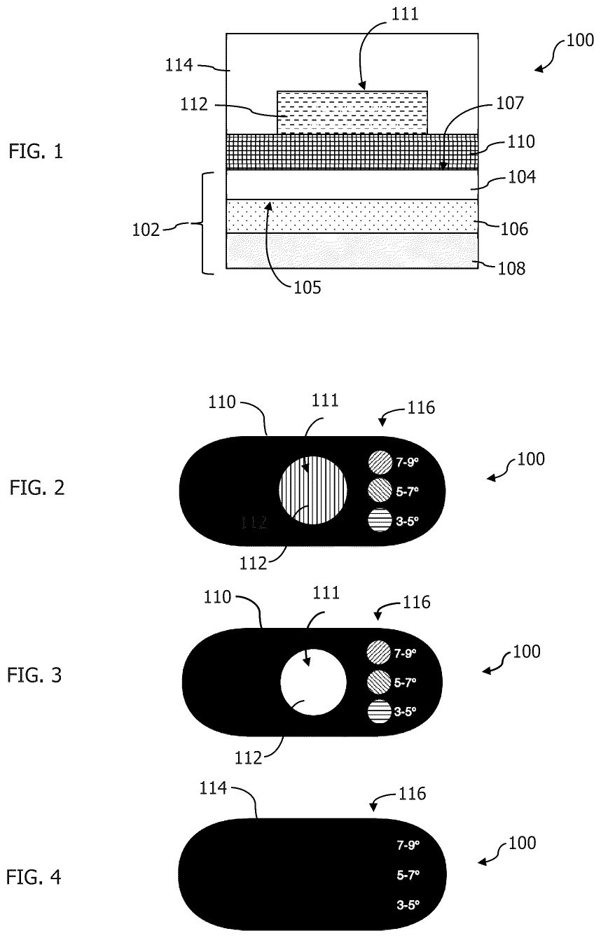

Referring now to FIG. 1, a temperature indicator label 100 cross-section showing the layers, a stack-up of the layers one on top of another, thereof has a label stock 102 comprising three layers—a substrate 104, an adhesive layer 106 applied to a bottom surface 105 of the substrate, and a release liner 108 covering the adhesive layer 106 opposite the substrate 104. Printed onto a top surface 107 of the substrate 106 is a graphic layer or a pre-selected background color layer 110, such as a black background as shown in FIGS. 2-4. An example of a graphic is shown in U.S. Pat. No. 9,902,861, which is incorporated herein by reference in its entirety. A temperature indication composition 112 is positioned on top of the graphic or preselected colored background. A transparent polymeric layer 114 is present over the temperature indication composition 112 to protect it from environmental conditions and handling.

With reference to FIGS. 1-4, the transparent polymeric layer 114 is present immediately above the temperature indication composition with a thickness sufficient to protect (insulate) the temperature indication composition 112 from sensing the surrounding environment temperature rather than sensing the temperature of a thermal mass to which the label 100 is affixed. The temperature indication composition 112 is clearly visible through the polymeric coating 114. The insulating aspect of the polymeric layer 114 is balanced relative to a relatively non-insulating thickness of the label stock 102 so that the temperature indication composition does sense the product to which it is attached, i.e., senses the thermal mass.

The label stock 102 can include a material selected from the group consisting of biaxially oriented polypropylene (BOPP), polypropylene, polyethylene, polyvinyl chloride, cellulose acetate, polyester, polyester G, or cyclic olefin copolymer films, paper, paper laminations, and foil laminations. A commercially available BOPP is available from Strata-Tac Inc. of St. Charles, Illinois. The label stock 102 has a thickness that enables it to be characterized as flexible rather than rigid and non-insulating as noted above. A flexible substrate can conform to a surface of a product whether said surface is flat or arcuate or undulating, etc. The thickness of the label stock 102 is in a range of 2 mils to 15 mils, more preferably 4 mils to 12 mils, and even more preferably 5 mils to 9 mils.

The adhesive is any commercially available pressure sensitive adhesive suitable to the material defining the packaging of the product. The adhesives include but are not limited to acrylics, natural rubbers, and silicones. Adhesives for use on food products, medical products, and blood bags preferably meet criteria set by the Food and Drug Administration. When the optional liner is present, the indicator is characterized as a peel-and-stick label.

The flexible, clear polymeric coating, i.e., the polymeric layer 114, results in an indicator 100 that can endure extended handling and provides environmental control protection, therefore. First, the polymeric layer 114 acts as thermal mass, so that when the indicator 100 is removed from its activation environment, such as a refrigerator for the example labels provided in FIGS. 2-4, to be applied to a product to be monitored, the indicator 100 does not change temperature too quickly and allows ample time for application to the product. Second, once the indicator 100 is applied to the substrate, the polymeric layer 114 insulates the temperature indication composition 112 so that the outside environment is not monitored, just the core temperature of the thermal mass of the product is monitored by the indicator. The polymeric layer 114 has a thickness range of 10 mils to 80 mils, preferably 20 mil to 40 mils plus or minus manufacturing tolerances thereof.

The polymeric layer 114 is selected from the group consisting of polyurethanes, silicones, acrylics, and epoxies. A transparent polymer enables viewing of the temperature indication composition 112 therethrough. A transparent polymer for this invention is one through which the indicator graphics can be clearly seen without a cloudy or hazy appearance. Many commercial polymeric layers are rigid at refrigeration temperatures and while they may bond acceptably to irregular substrates, especially small indicators, a polymer flexible at refrigeration temperatures is desirable because the indicator will conform to the substrate, for example, a blood bag, for good adhesion and maintaining contact with the surface of the substrate. Polymers should have a Shore A durometer of less than 55, with less than 45 preferred. Elongation is another measure of flexibility. An elongation of greater than 50% is effective, with greater than 100% preferred. These values are typically measured at room temperatures so each polymer must be evaluated at refrigeration temperatures to determine their properties, because durometer and elongation will change differently with temperature for each type of polymer.

Still referring to FIGS. 1-4, the temperature indication composition 112 has a pre-selected temperature for a color change that is irreversible within an operable range for the thermal mass to which it is intended to be adhered or affixed. An example for this would be a blood bag indicator that activates at −15° C. to −20° C. and changes at 10° C. Once changed, the temperature indication composition 112 cannot redevelop color unless frozen again, which should not occur during normal use for a blood bag. The temperature indication composition 112 can be reset to its opaque, colored state if cooled to −15° C. to −20° C. The temperature indication composition 112 can be applied to the stock label 102 by dotting, flexography, screen printing, gravure, and other commercial methods. In one embodiment, the temperature indication composition 112 may be termed an “ink” because of its method of application and deposited on a sub-portion of the graphic layer or background colored layer 110. The deposit 111 of the temperature indication composition 112 may be in the form of a spot, region, field, or zone, whichever is appropriate for the thermal mass being monitored.

Referring to FIGS. 2, 3, and 4, the temperature indicators 100 include a composition 112 that changes from a first color (red as in FIG. 2 or white as in FIG. 3) to a second color (black as in FIG. 4) at a temperature at or above the pre-selected temperature. The first color (below trigger temperature) can be white, or a color, such as blue, red, green, yellow, etc. The second color (above the trigger temperature) is typically a darker color, for example, black. But if the first color is white, then it can change to any other color. The second color is defined by a background color layer 110 or a graphic layer on which the temperature indication composition 112 is applied. Therefore, a change from a color of the temperature indication composition 112 to black indicates that the product has experienced a temperature breach and that the temperature indication composition 112 is now transparent, as shown in FIG. 4. Examples of an image or graphic as the background layer are disclosed in U.S. Pat. No. 9,902,861, which can be hidden below the temperature indication composition 112 to be revealed when the temperature indication composition becomes transparent.

Still referring to FIGS. 2, 3, and 4, the indicators 100 each include a liquid crystal ink section 116 defining a real time temperature scale, positioned to the left of the temperature indication composition 112 in the figures, for a selected defined range of temperature selected to be relative to the color change temperature of the temperature indication composition 112. For example, the real time temperature scale has a range such that the highest temperature liquid crystal dot will be transitioning out of its color range when the temperature indication composition 112 is ready to change states (from a colored state to a transparent state). The listed liquid crystal temperatures shown on FIGS. 2, 3, and 4 are indicative of a 10° C. indicator. Here, the 3-5° C. dot is blue, the 5-7° C. dot is green and the 7-9° C. dot is brown. The temperature indicator has both the ability to communicate threshold and real-time temperature, which is beneficial because real-time temperature readings can be compared with the irreversible threshold indications to communicate how closely the current temperature is to the breach temperature. Thus, giving information related to the timeframe for the temperature breach. The liquid crystal ink section 116 can serve as a warning to the user that the product is getting too warm and needs to be returned to refrigeration.

In one embodiment, the indicators 100 an activation coating that permanently stays colored when the indicators have been activated and are ready for use. This would serve as proof that an indicator in use that has triggered, had been activated.

Referring now to FIG. 8, the indicator 100 shown on the left is in an un-activated state. The indicator shown to the right thereof is in an activated state, at least with respect to the largest circle 113. The largest circle 113 represents the temperature indication composition 112, which is configured on this label to be a 10° C. indicator that appears red when frozen, then remains red until its temperature rises above 10° C. At 10° C. and above, the largest circle 113 will change from red to clear, thereby revealing the black background and/or an indicia hidden therebelow. The three smaller circles, one each juxtaposed to 4° C., 6° C., and 8° C. respectively, form a liquid crystal ink section 116. These smaller circles will not have color at once. The table below describes the appearance of each of the smaller circles over a temperature range of 3° C. to 9° C. temperature.

| Blood Bag Core | Liquid Crystal | Liquid Crystal | Liquid Crystal |
|---|---|---|---|
| Temperature ° C. | Dot 4° C. | Dot 6° C. | Dot 8° C. |
| 3 | Tan/Red | | |
| 4 | Green | | |
| 5 | Blue | Tan/Red | |
| 6 | | Green | |
| 7 | | Blue | Tan/Red |
| 8 | | | Green |
| 9 | | | Blue |

The temperature indication composition 112 includes an organic compound that experiences a change in opacity when changing phase from crystalline solid to a liquid or vice versa and includes a binder. The temperature indication composition 112 has a color in the solid phase and is clear (transparent) in the liquid phase. The organic compound can be referred to herein as a phase change material or as a temperature indication compound. Alkanes, esters, alcohols, carboxylic acids, ketones, amides, ethers, aromatics etc., all exhibit varying degrees of change in opacity, especially when present in a small particle size, such as the small particle size capable by microencapsulation thereof as a core stored within a microcapsule shell wall.

Examples of alkanes would be normal straight chain alkanes composed of 6 to 40 carbons (n-hexane to n-tetracontane). Examples of branched alkanes would be 2,6-dimethyl octadecane, 2-methyl octadecane, 3-methyl octadecane, 4-methyl octadecane, 2-ethyl octadecane, 3-ethyl octadecane, 2,6-diethyloctadecane, and other variations in carbon chain length and number of branching groups.

Examples of esters include but are not limited to aliphatic esters consisting of methyl, ethyl, propyl, butyl, pentyl, hexyl, heptyl, octyl, capryl, lauryl, myristyl, palmityl, stearyl, arachidyl, and behenyl esters of caprylic acid, capric acid, lauric acid, myristic acid, palmitic acid, stearic acid, arachidic acid, and behenic acid; isopropyl palmitate, cyclohexyl palmitate, 2-ethyl hexyl myristate, 2-methyl butyl stearate, dimethyl-1,4-cyclohexanedicarboxylate; aromatic esters such as benzyl stearate, benzyl laurate, benzyl myristate, benzyl palmitate, benzhydryl laurate, benzhydryl myristate, 2-naphthyl laurate, 2-naphthyl myristate.

Examples of alcohols include but are not limited to normal aliphatic from 10 carbons (decanol) to 30 carbons (tricontanol) with the alcohol in the normal (1) position or any position (2, 3, 4, etc.) along the carbon chain; cyclic alcohols such as cyclopentanol, cyclohexanol, cyclooctanol; aromatic alcohols such as benzyl alcohol, benzhydryl alcohol, 4-methyl benzyl alcohol.

Examples of carboxylic acids include but are not limited to caprylic acid, capric acid, lauric acid, myristic acid, palmitic acid, stearic acid, arachidic acid, behenic acid, pentadecanoic acid, heptadecanoic acid, tridecanoic acid, nonanoic acid, undecanoic acid, heptanoic acid, nonadecanoic acid.

Examples of ketones include but are not limited to symmetrical aliphatic ketones with chains of 4 (5-nonanone) to 10 (11-heneicosanone) carbons on either side of the ketone group; non-symmetrical aliphatic ketones such as 2-decanone, 3-decanone, 4-decanone, and similar corresponding isomers of undecanone, dodecanone, tridecanone, tetradecanone, pentadecanone, hexadecanone, heptadecanone, octadecaonone, nonadecanone, eicosanone, and heneicosanone; aromatic ketones such as butyrophenone, butyl phenyl ketone, hexyl phenyl ketone, cyclohexyl phenyl ketone, dodecanophenone, tetradecanophenone, octadecanophenone, and 4-isobutylacetophenone.

Examples of amides include but are not limited to capric analide, caprylanilide, lauranilide, myristanilide, palmitanilide, stearanilide, behenanilide; N-methyl through N-dodecyl amides of capric, caprylic, lauric, myristic, palmitic, stearic acids.

Examples of ethers include but are not limited to aliphatic ethers such as symmetrical n-alkyl ethers in order of increasing carbon chain from amyl ether to octadecyl ether, non-symmetrical ethers such as hexyl octyl ether, methyl octyl ether, octyl decyl ether, and aromatic ethers such as diphenyl ether, phenoxy butyl ether, phenoxy hexyl ether, methoxy naphthalene and other alkyloxy derivatives.

Examples of aromatics include but are not limited to o-xylene, m-xylene, p-xylene, naphthalene, 1,3,5-trimethylbenzene, and 1,2-dimethylnaphthalene.

In many cases an organic compound can have a freezing point temperature that is lower than the melting point temperature. This is due to supercooling. The difference between the melting and freezing point is the hysteresis. The hysteresis can be controlled by selection of the organic compound and manipulating the organic compound's particle size. The clarity of the final coating, when the compound is in the liquid phase, can be improved by matching refractive indices of the organic compound and the binder.

Experimentation has determined that the purer the organic compound, the sharper the melting point transition between the opaque state and the transparent state, hence a more accurate indicator. Purity is the amount of the exact chemical compound of interest. For example, 98% pure compound A contains 98% of compound A and 2% of either reactants or by-products. Chemicals can be purchased with a known purity or the purity can be determined by methods such as chromatography. While it is not a quantifiable method of purity, differential scanning calorimetry (DSC) can show a sharp melting point, which is an indication of high purity. The purity of the organic compound is typically at least 92% pure, more preferably at least 95% pure, and even more preferably at least 98% pure. Thus, unlike the composition in U.S. Pat. No. 9,902,861, no nucleation aid need be present in the temperature indication composition.

Combinations of compounds can be utilized but a compound's melting point temperature range tends to increase with increasing concentration of a different compound. The exception is the eutectic point of the blend. A binary mixture will have a sharp melting point at the eutectic. This allows for alternative melting point from pure compounds. For example, tetradecane melts at 6° C. and hexadecane melts at 18° C. These two compounds when blended at 11% hexadecane and 89% tetradecane form a eutectic with a melting point of 2° C.

It has further been determined that in most cases aromatic compounds exhibit greater supercooling than aliphatic compounds. Compounds with both aromatic and aliphatic groups can vary widely and with the proper balance of aromatic to aliphatic group can have the greatest level of hysteresis between the melting and freezing point. It is believed that when both an aromatic group and aliphatic group are present, a competition between the aromatic interactions and van der Waals forces exists such that crystallization temperature is suppressed. The level of suppression depends on the molecular size and structure of both the aliphatic and aromatic groups. The melting and freezing points must be determined empirically.

The hysteresis between melting point and freezing point is also dependent upon the size of the microcapsules in which said organic compound is encapsulated. Smaller microcapsules exhibit greater hysteresis due to greater supercooling because there are statistically fewer sites for nucleation. The microcapsules produced have a mean particle size in a range of 1 μm to 50 μm, more preferably 20 μm to 40 μm. In one embodiment, the mean particle size is in a range of 30 μm to 40 μm. Microcapsules of 5 μm or less can have a hazy appearance when aliphatic compounds are used. This is due to the microcapsule wall polymers and coating binders having a higher refractive index than the core phase. Using a compound with some aromaticity will increase the refractive index for a better match with the binder, thereby providing greater clarity in the dry coating. Greater clarity could also be achieved by using a lower refractive index binder, but most commercial and economical binders have higher refractive indices.

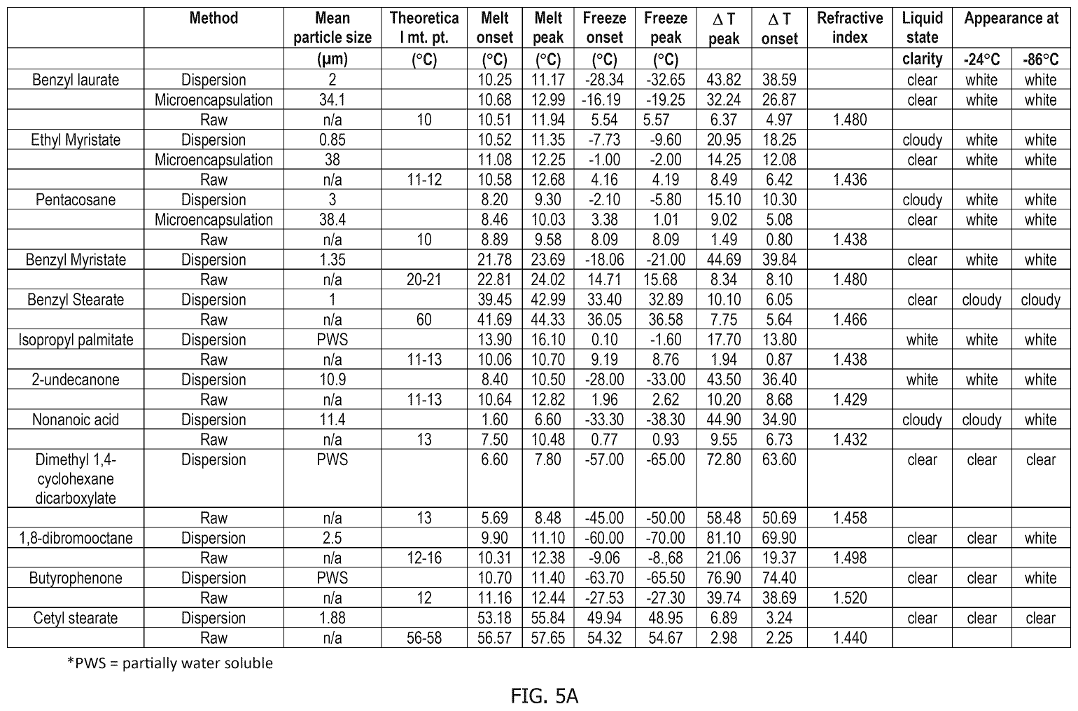

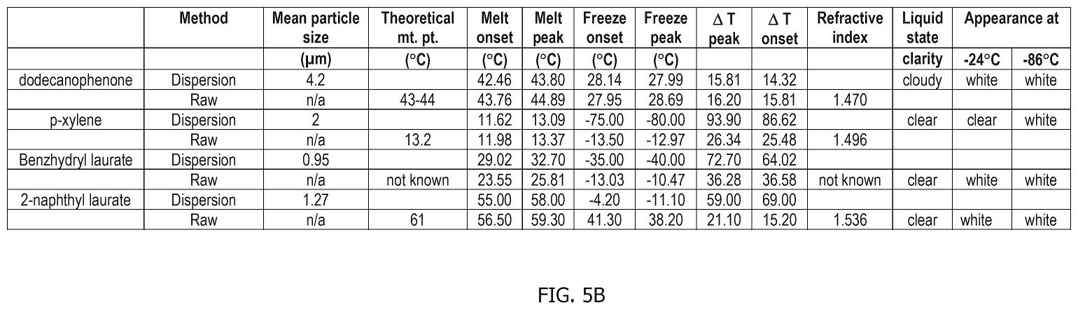

Binders that can be used in this invention include but are not limited to acrylic, styrene acrylic, styrene butadiene, ethylene vinyl acetate, and polyvinyl alcohol. One example binder is polyvinyl alcohol, which has a refractive index of 1.48. The closer the refractive index of the organic compound to PVA, the better. A difference of ±0.05 is considered optimal for small (less than 5 micron) microcapsules/particle/droplets to achieve transparency. For 10 micron particles/microcapsules/droplets a range of ±0.52, as seen in the examples in FIGS. 5A and 5B, is considered acceptable.

Microencapsulation methods are discussed in U.S. Pat. No. 9,902,861 as follows: any of a variety of processes known in the art may be used to form the microcapsules. Chemical techniques may be used, such as dispersing droplets of molten core material in an aqueous solution and to form walls around the droplets using simple or complex coacervation, interfacial polymerization and in situ polymerization, all of which are well known in the art. For example, methods are well known in the art to form gelatin capsules by coacervation, polyurethane or polyurea capsules by interfacial polymerization, and urea-formaldehyde, urea-resorcinol-formaldehyde, and melamine formaldehyde capsules by in situ polymerization. In one embodiment, the microcapsules are gelatin or gelatin-containing microcapsules, which may be made using well-known methods such as the phase separation processes or coacervation processes, such as those described in U.S. Pat. Nos. 2,800,457 and 2,800,458.

Coacervation is one example process that produces capsules of 2-1200 μm relative particle size. In simple coacervation, a desolvation agent is added for phase separation. In complex±coacervation, complexation between two oppositely charged polymers typically is utilized. For example, the core material (usually an oil) is dispersed into a polymer solution (e.g., a cationic aqueous polymer, gelatin, etc.) and a solution containing a second polymer (e.g., an anionic, water soluble, gum Arabic) solution is added thereto, which causes wall material to deposition onto the core material particles when the two polymers form a complex. The formation of the complex may be initiated by the addition of a salt, by changing the pH, changing the temperature, and/or by diluting the solution. After formation of the complex and hence the microcapsules, the microcapsules are stabilized by crosslinking, desolvation, or thermal treatment.

The wall material may be a gum, carbohydrate, cellulose material, lipid, or protein. Example gums include, but are not limited to, gum Arabic, sodium alginate, and carrageenan. Example carbohydrates include, but are not limited to, starch, modified starch, dextran, maltodextrin, agarose, and sucrose. Example cellulose materials include, but are not limited to, carboxymethylcellulose and methylcellulose. Example lipids include, but are not limited to, bees wax, stearic acid, and phospholipids. Example proteins include, but are not limited to, gelatin, albumin, and soy protein.

Selection of the right combination of compound and control of its particle size in microcapsules or a dispersion is important for an accurate indication and a freezing point temperature that is well below the melting point yet can be practically activated. First, the compound must have a sharp melting point at the target temperature. For a blood bag indicator, one target would be 10° C. (or higher if there is a need for an offset temperature to accurately indicate the core temperature of the blood bag). Second, a 10° C. blood bag temperature indicator must be activated to turn white (or colored) at temperatures below 0° C. but not below −20° C. This temperature range can be easily activated by a standard freezer. If the activation temperature is lower, then an ultra-low temperature freezer is required. If the activation temperature is above 0° C., the color could reform when the blood bag is returned to the refrigerator. Referring to FIG. 5A, benzyl laurate at 2 microns has a freeze point below-25° C. When benzyl laurate's mean size is 34 microns, its freeze point is −15 to −20° C., which is within the range of a standard freezer. As you can see from FIGS. 5A and 5B, a wide range of target melting point temperatures can be achieved, and their freeze points manipulated to suit an application. The most useful and practical temperature ranges for ascending temperature indicators are 0 to 60 C for melting point and −20 to 40 C for freeze point. But temperatures outside of these ranges are possible.

### Example Formulations

Microencapsulation of the organic compound can be made with a gelatin carboxy methyl cellulose microcapsule according to the following example general formula:

TABLE 1

| Material | Manufacturer | % Range | Purpose |
|---|---|---|---|
| Organic Compound | Sigma Aldrich | 25-40 | melting point of 10° C. |
| 300 Bloom Gelatin | Gelita | 1-5 | Microencapsulation |
| Material | | | Wall |
| Carboxy methyl | Ashland | 0.1-0.8 | Microencapsulation |
| cellulose Material | | | Wall |
| Deionized water | | 50-80 | Carrier and |
| medium | | | encapsulation |
| 10% HCl solution | Sigma Aldrich | 0.05-1.0 | pH adjustment |

Target size range is 10 μm-40 μm.

These microcapsules can be formulated into a coating according to the following example general formula:

TABLE 2

| Material | Manufacturer | % Range | Purpose |
|---|---|---|---|
| Microcapsule Slurry | Above | 30-60 | Temperature Indication |
| Polyvinyl alcohol | Sekisui | 3-20 | Binder and Rheology |
| Modifier | | | |
| Water | | 35-65 | |
| Preservatives | Arxada | 0.05-0.50 | Anti-Microbial |

In an alternative embodiment, the organic compound can be made directly into a dispersion, without being microencapsulated, according to the following example general formula:

TABLE 3

| Material | Manufacturer | % Range | Purpose |
|---|---|---|---|
| Organic Compound | Sigma Aldrich | 2-20 | Temperature Indication |
| Polyvinyl Alcohol | Selvol | 5-30 | Binder and Rheology |
| Modifier | | | |
| Water | | 50-80 | Carrier and Solvent |
| Preservative | Arxada | 0.05-0.50 | Anti-Microbial |

### WORKING EXAMPLES

### Example 1

### Microencapsulation of Benzyl Laurate, an Organic Temperature Indication Compound.

Benzyl laurate was microencapsulated in a gelatin carboxy methyl cellulose microcapsule wall following known methods according to the formula set forth in Table 4 below.

TABLE 4

| Material | Manufacturer | % Range | Purpose |
|---|---|---|---|
| Benzyl Laurate | Sigma Aldrich | 50 | Temperature |
| 10° C. | | | Indication |
| 300 Bloom Gelatin | Gelita | 4.98 | Microencapsulation |
| Material | | | Wall |
| Carboxy methyl | Ashland | 0.55 | Microencapsulation |
| cellulose Material | | | Wall |
| Deionized water | | 243.8 | Carrier and |
| medium | | | encapsulation |
| 10% HCl solution | Sigma Aldrich | as needed | pH adjustment |
| 50% Glutaraldehyde | Sigma Aldrich | 1.33 | Crosslinker |
| Soln | | | |

The target size range is a mean particle size of 10 μm-40 μm for the resulting microcapsules. A slurry of said microcapsules was mixed with polyvinyl alcohol to make a coating according to the formula in Table 5 below.

TABLE 5

| Material | Manufacturer | % Range | Purpose |
|---|---|---|---|
| Microcapsule Slurry | Example 1 | 30-60 | Temperature Indication |
| Polyvinyl alcohol | Sekisui | 40-70 | Binder and Rheology |
| Modifier | | | |
| Cosmocil CQ | Arxada | 0.05-0.50 | Biocide |
| Calcium Propionate | Sigma Aldrich | 0.05-0.50 | Biocide |

The water-based microcapsule slurry was blended with polyvinyl alcohol as a binder. The coating was dotted onto a substrate printed with a black background. The coating was dried, and the thickness measured. When placed in a −24° C. freezer, the coating turned white. It cleared when warmed to 11.5-12.5° C. When placed on a blood bag, the label accurately indicates a blood core temperature excursion over 10° C. due to temperature difference between core and bag exterior.

### Example 2

### Microencapsulation of Tetradecane, a Temperature Indication Compound.

Tetradecane was microencapsulated in a gelatin carboxy methyl cellulose microcapsule wall following known methods according to the formula set forth in Table 6 below.

TABLE 6

| Material | Manufacturer | % Range | Purpose |
|---|---|---|---|
| Tetradecane | Sigma Aldrich | 50 | Temperature |
| 6° C. | | | Indication |
| 300 Bloom Gelatin | Gelita | 4.98 | Microencapsulation |
| Material | | | Wall |
| Carboxy methyl | Ashland | 0.55 | Microencapsulation |
| cellulose Material | | | Wall |
| Deionized water | | 243.8 | Carrier and |
| medium | | | encapsulation |
| 10% HCl solution | Sigma Aldrich | as needed | pH adjustment |
| 50% Glutaraldehyde | Sigma Aldrich | 1.33 | Crosslinker |
| Soln | | | |

Target size range is a mean particle size of 10 μm-40 μm for the resulting microcapsules. A slurry of said microcapsules was mixed with polyvinyl alcohol to make a coating according to the formula in Table 7 below.

TABLE 7

| Material | Manufacturer | % Range | Purpose |
|---|---|---|---|
| Microcapsule Slurry | New Example 1 | 30-60 | Temperature Indication |
| Polyvinyl alcohol | Sekisui | 40-70 | Binder and Rheology |
| Modifier | | | |
| Cosmocil CQ | Arxada | 0.05-0.50 | Biocide |
| Calcium Propionate | Sigma Aldrich | 0.05-0.50 | Biocide |

The water-based microcapsule slurry was blended with polyvinyl alcohol as a binder. The coating was dotted onto a substrate printed with a black background. The coating was dried, and the thickness measured. When placed in a −24° C. freezer, the coating turned white. It cleared when warmed to 5.5-6.5° C. When placed on a blood bag, the label accurately indicates a blood core temperature excursion over 6° C. during storage.

### Example 3

### Polyvinyl Alcohol Dispersion

50 grams of 20% polyvinyl alcohol aqueous solution was poured into a 100 mL Waring blender cup. While mixing the PVA solution, 3 grams of benzyl laurate was added slowly. Then mixing speed was increased. This was mixed until the mean size was 1.27 microns. The coating was dotted onto a substrate with a black background. The coating was dried, and the thickness measured. When placed in a −24° C. freezer the coating did not turn white. It had to be chilled using a cold spray, which can reach −65 F. Chill spray will not work effectively on an indicator with a thick polymer coating. When warmed the indicator changed at 11.5-12.5° C.

### Example 4

### Polyvinyl Alcohol Dispersion

30 grams of 20% polyvinyl alcohol aqueous solution was poured into a 100 mL Waring blender cup. While mixing the PVA solution, 2 grams of tetradecane was added slowly. Then mixing speed was increased. This was mixed until the mean size was 1.16 microns. The coating was dotted onto a substrate with a black background. The coating was dried, and the thickness measured. The coating turns white in the range of −10° C. to −13° C. When warmed, the indicator changed at 5.5° C.-6.5° C.

### Example 5

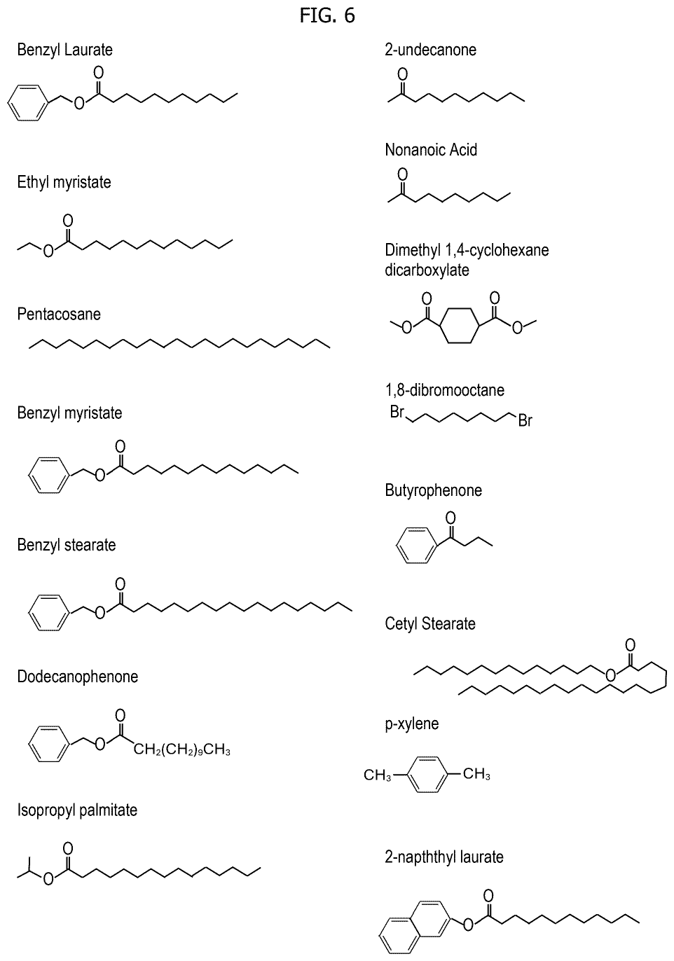

Using the table of example formulations with reference to the data in FIGS. 5A and 5B, sixteen organic compounds were tested with respect to effects of particle size and structure on hysteresis and coating clarity when the organic compound is in the liquid state. The organic compounds' chemical structures are shown in FIG. 6. The sixteen organic compounds were either aliphatic, aromatic, or both and were tested in two forms—raw and dispersed in a water-based binder. Three of the compounds, benzyl laurate, ethyl myristate, and pentacosane, were microencapsulated as well to a larger size than the dispersed samples. Raw samples were taken directly from their container and tested unmodified. The dispersed samples were made by adding 3 grams of liquified organic compound to 50 grams of warm 20% polyvinyl alcohol aqueous solution and emulsifying using a homogenizer to a size of less than 12 microns, and preferably less than 5 microns. The dispersion was then cooled and ready for application. This solution can be applied by many methods including dotting, screen printing, drawdown, and flexography, with no oily residue on the surface. This is unique in that many thermochromic inks would require microencapsulation to create a coating/ink that would be stable. Yet here microencapsulation was not required for all organic compounds. Emulsions with larger droplets, droplets having a mean average particle size of greater than 12 microns needed microencapsulation to form suitable inks.

Still referring to FIGS. 5A and 5B, a comparison of the data for aromatic compounds, aliphatic compounds, and compounds with both aromatic and aliphatic moieties, distinctly shows that aromatic compounds have greater supercooling, followed by compounds with some aromatic component, and then by the aliphatic compounds. The key data is the ΔT (difference in temperature) of the freeze and melt onsets, and the ΔT between the freeze and melt peaks on the digital scanning calorimeter (DSC). Since the peak ΔT and onset ΔT values are similar, for simplicity only the peak ΔT will be discussed. Para-xylene, 1,8-dibromo octane, and butyrophenone are the most purely aromatic of the compounds in the table. In the raw state, p-xylene has a ΔT of 26.43° C., 1,8-dibromo octane has a ΔT of 21.06° C., and butyrophenone has a ΔT of 39.74° C. The aliphatic compounds pentadecane, isopropyl palmitate, ethyl myristate, 2-undecanone, nonanoic acid, and cetyl stearate have ΔT values in the raw state ranging from 1.49 to 10.20° C. The remaining compounds have both an aromatic group and aliphatic group in their structures and their ΔT values in the raw state range from 6.37 to 60.81° C. It is believed that when both an aromatic group and aliphatic group are present, a competition between the aromatic interactions and van der Waals forces exists such that crystallization temperature is suppressed. The level of suppression depends on the molecular size and structure of both the aliphatic and aromatic groups.

The smaller the particle size of the organic compound in the coating binder, the greater the hysteresis or ΔT. Focusing on just the first three compounds, which have three different sizes, raw, dispersed to 3 microns or less, and microencapsulated to 34 to 38 microns, it is observed that in each case the ΔT increases with decreasing particle size. The remaining compounds were tested in the raw state and in a dispersion. In all cases except dodecanophenone, the ΔT of the dispersion is higher than the raw state.

To observe clarity when the organic compound is in the liquid state, and its whiteness when in the solid state, the dispersions of each compound were coated over a black background, such as black polyvinyl chloride (PVC) film, and then dried. Clarity was observed when the organic compound was above its melting point. Focusing again on the first three compounds, when the particle size is 34-38 microns, they all appear clear. However, when the size is 3 microns or less, coatings with ethyl myristate and pentadecane, having refractive indices of 1.436 and 1.438 respectively, appear cloudy. Benzyl laurate has a refractive index of 1.48 and it appears clear in a coating when at 2 microns. The remaining compounds were only tested at a small size. All compounds containing aromaticity and having a refractive index above 1.46 were clear. All aliphatic compounds with refractive indices below 1.46 were cloudy or white, except cetyl stearate. All coated compounds turned white when chilled to at least −86° C. except dimethyl-1,4-cyclohexane dicarboxylate, probably due to its low freeze temperature and partial water solubility, and cetyl stearate, whose crystalline state is only slightly opaque.

### Example 6

Indicators were created with the coating formula from Example 2 by dotting the same onto a black-colored, biaxially oriented polypropylene (BOPP) substrate that had a pressure sensitive adhesive (PSA) backing. Dots of the coating formula were tested over a range of thicknesses (dried coating thickness) in mils. The indicators were kiss cut and a silicon polymer was applied over the indicators. A range of thicknesses were tested for the silicone polymer as well. See the data below in Table F.

These were applied to refrigerated blood bags and tested for temperature response. An RTD was inserted into the blood bag to measure core temperature. The bags were allowed to warm while the temperatures at which the indicators changed were time-lapse recorded. Table 8 below is a summary of the results.

TABLE 8

| Silicone Polymer | | | Complete | |
|---|---|---|---|---|
| Thickness | Dot Thickness | Start of Change | Change | ΔT |
| (mils) | (mils) | (° C.) | (° C.) | (° C.) |
| 33 | 3 | 9.7 | 10.6 | 0.9 |
| 30 | 5.5 | 9.7 | 10.5 | 0.8 |
| 28 | 8.5 | 9.8 | 10.7 | 0.9 |
| 80 | 2.5 | 10.1 | 10.7 | 0.6 |
| 79 | 4.5 | 10.4 | 10.8 | 0.4 |
| 84 | 7.5 | 9.9 | 10.8 | 0.9 |
| n/a | 3.0 | 9.2 | 10.5 | 1.3 |
| n/a | 5.0 | 9.2 | 10.5 | 1.3 |
| n/a | 5.5 | 9.1 | 10.7 | 1.6 |

### Example 7

### Polymeric Coating Layer-Protection Study

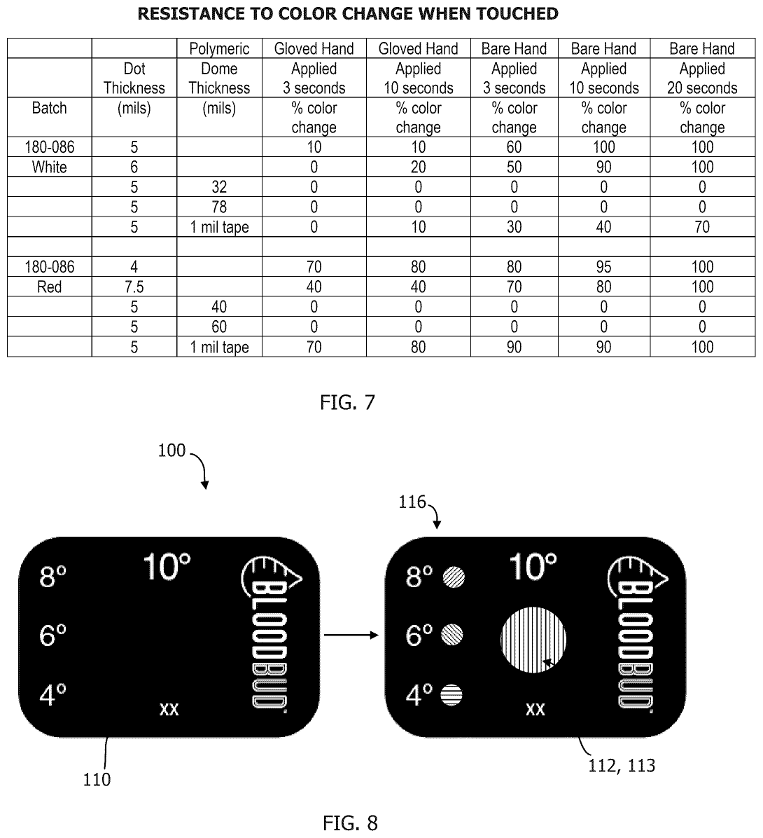

Temperature indicator labels were constructed according to the description set forth herein with respect to FIGS. 1-4 and the Example formulation of Example 1 and 2. Here, red food coloring was added to the organic compound to have a red indicator, as shown in FIG. 3, for a red to black color change. Dot thickness was recorded in the Table included herein as FIG. 7. The support substrate has a 3 mil layer of white BOPP and adhesive, collectively, on top of a 2.0 mil layer of PET and adhesive, collectively for a total support substrate thickness of 7.5 mils. To one of the indicators a flexible, clear polymeric coating was added over the temperature indication composition layer. The polymeric coating layer was a silicone having a thickness as listed in FIG. 7. Another set of indicators had a 1 mil pressure sensitive clear lamination tape applied over the temperature indication composition rather than a silicone polymer. The final set had no coating or tape applied thereover. Two indicators from this set were tested, one with a thicker coating of temperature indication composition than the other.

A chill plate was pre-conditioned by setting it to 3° C. and allowing it to soak for 15 minutes. The labels were activated by placement in a freezer at −22° C. for 5 minutes.

With a gloved hand, the labels were removed from the freezer and placed on the chill plate (still set at 3° C.). Because the labels without the polymeric coating over the ink changed color (to black) even without touching the temperature indication composition, cold spray was used to re-activate the labels once placed on the chill plate. The labels were covered with a clear acrylic plastic lid and left to sit on the chill plate for an hour.

With reference to the data in FIG. 7, the initial condition of the indicators was recorded. Then, with a gloved hand, while remaining on the chill plate, a finger was placed on the temperature indication composition of each label for 3 seconds. Any change was recorded. This process was repeated for each label. Then a gloved finger was applied for 10 seconds to each indicator. Then the glove was removed and a finger placed on the indicators for 3, 10, and 20 second intervals. Results were recorded at each interval. The addition of the thick polymeric coating prevented triggering of the indicator quite well. The tape did not provide substantial protection. Thicker coatings of temperature indication composition hold color longer than thinner.

### Example 8

The time available to apply the indicator without triggering the temperature indication composition was tested. The same sets of indicators as used for Example 2 were activated in a −24° C. freezer, then transferred to a 4° C. refrigerator where they were kept for over 1 hour. The indicators were removed from the refrigerator, a timer started, and the indicators were observed for when the color begins to change, and when it completely changes. The time for each indicator was recorded. The longest application times are for the indicators with the thickest dome, followed by the thinner dome, followed by the thick dot, and last by both the thin dot with and without tape. The test data is set forth below in Table 9.

TABLE 9
Time to Apply After Removal from Refrigerator

| | Dot | Dome | Time at start of | Time of complete |
|---|---|---|---|---|
| | Thickness | Thickness | Color Change | Color Change |
| Batch | (mils) | (mils) | (seconds) | (seconds) |
| 180-086 | 5 | | 7 | 24 |
| white | 6 | | 13 | 41 |
| | 5 | 32 | 24 | 64 |
| | 5 | 78 | 40 | 92 |
| | 5 | 1 mil tape | 5 | 24 |
| 180-086 | 4 | | 4 | 19 |
| red | 7.5 | | 10 | 33 |
| | 5 | 40 | 25 | 45 |
| | 5 | 60 | 35 | 71 |
| | 5 | 1 mil tape | 10 | 24 |

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

What is claimed is:

1. A temperature indication label comprising:
a substrate having an adhesive layer applied to a bottom surface thereof and a graphic layer or background color layer applied to the opposing top surface thereof, the substrate having a thickness in a range of 2 mil to 15 mils;
a deposit of a temperature indication composition on at least a portion of the graphic layer or background color layer; and
a transparent polymeric layer over and sealing the deposit of the temperature indication composition to the substrate, the transparent polymeric layer having a thickness in a range of 10 mils to 90 mils;
wherein the temperature indication composition comprises a binder and an organic compound, the organic compound having hysteresis at a pre-selected temperature for an irreversible color change from colored to transparent within an operable range for a thermal mass to which the temperature indication label is intended for adhesion;
wherein the refractive index of the organic compound and the refractive index of the binder are the same or closely matching.

2. The temperature indication label of claim 1, wherein the deposit of temperature indication composition has a dried thickness in a range of 3 mils to 8 mils.

3. The temperature indication label of claim 1, wherein the organic compound has a purity of at least 92%.

4. The temperature indication label of claim 3, wherein the organic compound includes at least one carbon ring.

5. The temperature indication label of claim 4, wherein the binder is polyvinyl alcohol.

6. The temperature indication label of claim 5, wherein the organic compound is encapsulated in a microcapsule having a mean particle size in a range of 1 μm to 50 μm.

7. The temperature indication label of claim 3, wherein the temperature indication composition was deposited as an aqueous dispersion of the organic compound in the polyvinyl alcohol, wherein the organic compound had a mean particle size less than 12 μm.

8. The temperature indication label of claim 1, wherein the organic compound is benzyl laurate, the binder is polyvinyl alcohol, and the thermal mass is a blood bag of blood and the operable range for a color change indication of the temperature indication label is 3° C. to 10° C.

9. The temperature indication label of claim 6, wherein the organic compound is encapsulated in a microcapsule having a mean particle size in a range of 10 μm to 40 μm.

10. The temperature indication label of claim 1, wherein the substrate comprises a material selected from the group consisting of biaxially oriented polypropylene (BOPP), polypropylene, polyethylene, polyvinyl chloride, cellulose acetate, polyester, polyester-G, or cyclic olefin copolymer films, paper laminations, foil laminations and combinations thereof.

11. The temperature indication label of claim 1, wherein the transparent polymeric coating is selected form the group consisting of polyurethanes, silicones, acrylics, epoxies, and combinations thereof.

12. The temperature indication label of claim 1, further comprising a liquid crystal ink real-time temperature measuring scale.

13. The temperature indication label of claim 1, wherein the organic compound is selected from the group consisting of benzyl laurate, benzyl myristate, benzyl stearate, dimethyl 1,4-cyclohexanedicarboxylate, butyrophenone, dodecanophenone, p-xylene, benzhydryl laurate, 2-naphthyl laurate, and combinations thereof.

14. The temperature indication label of claim 1, wherein the organic compound is selected from the group consisting of ethyl myristate, pentacosane, isopropyl palmitate, 2-undecanone, nonanoic acid, 1,8-dibromooctane, cetyl stearate, and combinations thereof.

15. A low temperature ascending indication label comprising:
a substrate having an adhesive layer applied to a bottom surface thereof and a graphic layer or background color layer applied to the opposing top surface thereof, the substrate having a thickness in a range of 2 mil to 15 mils;
a deposit of a temperature indication composition on at least a sub-portion of the graphic layer or background color layer; and
a transparent polymeric layer over and sealing the deposit of the temperature indication composition to the substrate, the transparent polymeric layer having a thickness in a range of 10 mils to 90 mils;
wherein the temperature indication composition comprises:
polyvinyl alcohol and an organic compound, the organic compound having hysteresis at a pre-selected temperature for an irreversible color change from colored to transparent within an operable range for a thermal mass to which the temperature indication label is intended for adhesion, and being selected from the group consisting of benzyl laurate, benzyl myristate, benzyl stearate, dimethyl 1,4-cyclohexanedicarboxylate, butyrophenone, p-xylene, ethyl myristate, pentacosane, isopropyl palmitate, 2-undecanone, nonanoic acid, 1,8-dibromooctane, and combinations thereof.

16. The low temperature ascending indication label of claim 15, wherein the deposit of temperature indication composition has a dried thickness in a range of 3 mils to 8 mils.

17. The low temperature ascending indication label of claim 15, wherein the organic compound has a purity of at least 92%.

18. The low temperature ascending indication label of claim 15, wherein the organic compound is encapsulated in a microcapsule having a mean particle size in a range of 10 μm to 40 μm.

19. The low temperature ascending indication label of claim 15, wherein the temperature indication composition was deposited as an aqueous dispersion of the organic compound in the polyvinyl alcohol, wherein the organic compound had a mean particle size less than 12 μm.

20. The low temperature ascending indication label of claim 15, further comprising a liquid crystal ink real-time temperature measuring scale.
